(19) United States
(12) Patent Application Publication
(10) Pub. No.: US 2026/0218819 A1
(43) Pub. Date: Jul. 30, 2026

(54) IN-SITU BRAIDED EXPANDABLE HOSE AND BRAIDING METHOD THEREOF

(71) Applicant: Dongguan Fugao Textile Co., Ltd., Dongguan (CN)

(72) Inventor: Jixiang SHAO, Dongguan (CN)

(73) Assignee: Dongguan Fugao Textile Co., Ltd., Dongguan (CN)

(21) Appl. No.: 19/629,380

(22) Filed: Mar. 26, 2026

(30) Foreign Application Priority Data
Feb. 4, 2026 (CN) 202610160446.3

(51) Int. Cl. F16L 11/12; D04C 1/06

(52) U.S. Cl. CPC F16L 11/12; D04C 1/06; D10B 2505/00

(57) ABSTRACT

A method for in-situ braiding an expandable hose includes: S1, arranging N groups of elastic filaments in a stretched state in parallel along a circumferential direction of an elastic inner tube in a stretched state on an outer wall of the elastic inner tube; and with each group of elastic filaments corresponding to two groups of braiding yarns, conducting figure-8 braiding with braiding yarns around the elastic inner tube to braid the N groups of elastic filaments in the stretched state successively onto the outer wall of the elastic inner tube in the stretched state to produce the expandable hose with a braided layer; and S2, releasing the expandable hose obtained in the S1 while the elastic inner tube is synchronously rotated and tensioned to enable retraction of the expandable hose to a natural state, and winding.

### CROSS-REFERENCE TO RELATED APPLICATIONS

This application claims priority to Chinese Patent Application No. 202610160446.3 with a filing date of Feb. 4, 2026. The content of the aforementioned application, including any intervening amendments thereto, is incorporated herein by reference.

### TECHNICAL FIELD

The present disclosure relates to the technical field of expandable hose braiding, and in particular, relates to an in-situ braided expandable hose and a braiding method thereof.

### BACKGROUND

Expandable hoses are retractable for storage when not in use, greatly saving storage and transportation space. Consequently, expandable hoses are widely used in household gardening, cleaning, fire fighting, industrial water supply, and other fields. The core design requirements of expandable hoses are as follows: The expandable hoses can expand smoothly under water pressure to deliver water and automatically retract to a compact state upon removal of water pressure. In addition, the expandable hoses shall exhibit sufficient pressure resistance and burst resistance during operation.

The utility model patent CN211344290U discloses an expandable hose, including: an elastic inner tube for a liquid to pass through, where the elastic inner tube has a retracted length and an expanded length respectively in the absence and presence of a pressure of the liquid passing through the elastic inner tube; and a braided layer wrapped on an outer circumferential surface of the elastic inner tube. The elastic inner tube and the braided layer together constitute a first expandable tube body. The first expandable tube body expands and retracts with the expansion and retraction of the elastic inner tube. Outer diameters of the first expandable tube body at a retracted length and an expanded length are close to outer diameters of the elastic inner tube at the retracted length and the expanded length, respectively. Thus, the braided layer protects the elastic inner tube from being punctured by external sand, gravel, and thorns, and can expand and retract synchronously with the elastic inner tube without abrading the elastic inner tube, which prolongs the service life of the first expandable tube body. Since the braided layer is braided on the elastic inner tube without gaps, the consumption of the braided layer is reduced, and the first expandable tube body is small in volume and light in weight and occupies little space. In addition, the first expandable tube body can be manufactured with an unlimited length. The main retraction force of the first expandable tube body is derived from the elasticity of the elastic inner tube. However, as the elasticity of the elastic inner tube decreases with the increase of service times, the expansion and retraction performance of the expandable hose is greatly compromised or the radial deformation of the elastic inner tube can hardly be constrained. When the water flow rate in the expandable hose increases, the elastic inner tube expands and the water flow becomes unstable, which easily causes structural damage to the expandable hose.

The Chinese invention patent publication No. CN103090128B discloses an expandable and retractable hose. According to FIG. 5, FIG. 6, and the description of this patent, this hose can automatically expand longitudinally and transversely when fluid pressure is applied, and can automatically expand longitudinally to a length 6 times its unexpanded or retracted length. When the fluid pressure inside the hose is released, the hose automatically retracts to the retracted state. The hose includes an inner tube made of an elastic material and an outer tube made of a non-elastic material. The inner tube is coaxially located within the outer tube in both the retracted state and the expanded state. The outer tube and the inner tube are fixedly connected at two ends. When the hose transitions between the retracted state and the expanded state, the outer tube moves transversely and longitudinally relative to the inner tube. In this invention, the elastic inner tube needs to be inserted into the non-elastic outer tube. To accommodate such an assembly structure, the inner tube and the outer tube are in contact and fixedly connected only at their end junctions, and middle portions of the inner tube and the outer tube are not attached to each other. It can be seen from the above prior art that the driving force for the above hoses to retract to their original length is derived from the elasticity of the inner tube itself. Once the inner tube undergoes excessive elastic deformation, the retraction force of the hose will decrease, which is adverse to the retraction of the hose.

### SUMMARY OF PRESENT INVENTION

An objective of the present disclosure is to provide a method for in-situ braiding an expandable hose. In the present disclosure, elastic filaments in a stretched state are in-situ braided into a braided layer on a surface of an elastic inner tube synchronously in a stretched state through braiding yarns. The elastic filaments are arranged coaxially along an outer wall of the elastic inner tube. The elastic filaments distributed coaxially along a circumference of the elastic inner tube are used in cooperation with the braiding yarns to effectively constrain and limit an elastic inner tube, thereby improving the reliability and stability of the expandable hose during use while ensuring the retraction force.

To solve this technical problem, the present disclosure adopts the following technical solutions: A method for in-situ braiding an expandable hose is provided, including the following steps:
S1, arranging N groups of elastic filaments in a stretched state in parallel along a circumferential direction of an elastic inner tube in a stretched state on an outer wall of the elastic inner tube; and with each group of elastic filaments corresponding to two groups of braiding yarns, conducting figure-8 braiding with braiding yarns around the elastic inner tube to braid the N groups of elastic filaments in the stretched state successively onto the outer wall of the elastic inner tube in the stretched state to produce the expandable hose with a braided layer; and
S2, synchronously rotating and tensioning the expandable hose and the elastic inner tube, releasing the expandable hose to enable retraction of the expandable hose to a natural state, and winding.

Preferably, the figure-8 braiding in the S1 is implemented by an in-situ braiding apparatus; and the in-situ braiding apparatus includes a braiding unit arranged on a support, where a first feeding unit configured to supply the elastic inner tube and a second feeding unit configured to supply the elastic filaments are provided below the braiding unit; a rotary hook and a winding unit are provided above the braiding unit;
the first feeding unit, the second feeding unit, and the winding unit are rotated synchronously through a rotational speed adjustment assembly; and
along a discharging direction of the expandable hose, a synchronous material elongation assembly driven synchronously by the rotational speed adjustment assembly is further provided between the winding unit and the rotary hook.

As a further improvement, the braiding unit includes a drive motor horizontally arranged above the support, and an 8-shaped annular track that includes an inner track and an outer track and is arranged on a table surface of the support; driven by the drive motor, adjacent dials are rotated in opposite directions to drive spindles located on the inner track and the outer track to move cyclically along the 8-shaped annular track with intersecting paths, such that elastic filaments passing through middle portions of the dials are cross-braided into the braided layer.

As a further improvement, a guide tube configured to introduce elastic filaments is provided at a center of each dial, and a pre-positioning tube arranged coaxially with the guide tube is provided below the guide tube; and

the guide tube and the pre-positioning tube are spaced apart and fixedly connected by a U-shaped connector.

As a further improvement, the first feeding unit includes a first nip roller assembly configured to cooperate with the winding unit to tension the elastic inner tube in a feeding direction; and

the second feeding unit includes a rotation roller, a separation plate provided with through holes one by one, a support frame, and a second nip roller assembly sequentially in a feeding direction of elastic filaments.

As a further improvement, elastic filaments are supplied by the second feeding unit; and elastic filaments stored on the rotation roller pass through a separation plate provided with through holes for the elastic filaments to pass through one by one, the support frame, and the second nip roller assembly sequentially along a feeding direction of the elastic filaments, then pass through guide passages formed inside a positioning ring to enter guide tubes and pre-positioning tubes one by one, and are then guided along a length direction of the elastic inner tube to a braiding point at which the elastic filaments are braided together with braiding yarns into the braided layer.

Preferably, the synchronous material elongation assembly synchronously pulls the elastic filaments and the elastic inner tube to stretch to a length 2 times to 4 times an original length. The synchronous material elongation assembly is linked with the rotational speed adjustment assembly to simultaneously pull the elastic inner tube and the elastic filaments such that the elastic filaments and the elastic inner tube are synchronously stretched from a natural length to a length 2 times to 4 times the natural length. Consequently, the elastic inner tube and the elastic filaments can maintain a consistent pre-stretched state in a braiding region for in-situ braiding, thereby enabling a synchronous deformation after water is introduced.

As a further improvement, the rotational speed adjustment assembly includes a second synchronizing shaft driven by a drive motor to rotate, and the second synchronizing shaft synchronously drives a first synchronizing shaft to rotate through a synchronous chain-gear assembly; the second synchronizing shaft drives a pulling roller of the synchronous material elongation assembly to rotate through a transmission gear; the second synchronizing shaft drives the winding unit to rotate synchronously through a winding chain-gear assembly; the first synchronizing shaft drives the first nip roller assembly of the first feeding unit through a first chain-gear assembly; and the first synchronizing shaft drives the second nip roller assembly of the second feeding unit through a second chain-gear assembly. In the present disclosure, the power of the same motor is synchronously distributed to the first/second feeding units, the synchronous material elongation assembly, and the winding unit through the rotational speed adjustment assembly to ensure a consistent linear velocity for the elastic inner tube, the elastic filaments, and the finished hose throughout the entire braiding and winding process. This design can avoid braiding defects or slack elastic filaments caused by uneven local tension and ensure that the elastic inner tube, the elastic filaments, and the expandable hose maintain a consistent linear velocity and tension state throughout the in-situ braiding and winding process. Consequently, the qualified rate of finished products is improved to 95% or more.

A second objective of the present disclosure is to provide an in-situ braided expandable hose.

Preferably, the expandable hose includes an elastic inner tube and a braided layer that is braided on an outer wall of the elastic inner tube and is capable of expanding and retracting synchronously with the elastic inner tube. The braided layer is formed through the interlaced braiding of a plurality of strands of braiding yarns with a plurality of groups of elastic filaments arranged along an axial direction of the elastic inner tube. When the expandable hose is in a natural elongated state, the elastic filaments remain pre-stretched to provide an additional retraction force and a circumferential limiting effect for the elastic inner tube.

As a further improvement, the expandable hose is capable of being threadedly connected to a water source or a spray nozzle through connectors at two ends of the expandable hose; the expandable hose is tightly sleeved onto the connectors through fastening rings; and a flexible connecting sleeve is fixed on an outer side of each of junctions between the expandable hose and the connectors. In the present disclosure, the arrangement of the flexible connecting sleeve facilitates a user in manually achieving the threaded connection of the expandable hose with the connectors to a spray nozzle or a water source, such as a water supply pipe or a faucet. This design enhances the convenience of use of the present disclosure.

As a further improvement, the flexible connecting sleeve is fixedly arranged on a connector through a deformation of the flexible connecting sleeve. In the present disclosure, the connector is typically a hardware fitting with an undercut on a surface. The flexible connecting sleeve achieves a reliable connection with the hardware fitting by enclosing the undercut of the connector through a deformation of the flexible connecting sleeve.

As a further improvement, the flexible connecting sleeve includes a wrapping portion tightly fitted to a connector through a deformation, and an extension portion configured to enclose a junction between the expandable hose and the connector. In the present disclosure, the flexible connecting sleeve is preferably made of a thermoplastic elastomer (TPE) through integral molding. With the integrally formed flexible connecting sleeve in the present disclosure, a user can conveniently hold an end of the expandable hose to connect or disconnect the expandable hose to or from a water source or a spray nozzle.

As a further improvement, the extension portion is provided with hollowed-out gaps that are spaced apart. In the present disclosure, the spaced hollowed-out gaps formed in the extension portion of the flexible connecting sleeve can accommodate bending between the hardware fitting and the expandable hose. This design prevents the expandable hose from kinking, ensures smooth water flow, and reduces structural damage to the expandable hose.

As a further improvement, when no water is flowing in the expandable hose, a gap exists between the extension portion and the expandable hose. The flexible connecting sleeve of the present disclosure accommodates radial expansion of the expandable hose.

As a further improvement, the flexible connecting sleeve is provided with concave-convex anti-slip portions to improve the stability and reliability of hand-held operation.

With the above technical solutions, the present disclosure achieves the following beneficial effects:

In the present disclosure, pre-stretched elastic filaments and braiding yarns are braided together along a figure-8 intersecting path on an outer wall of a synchronously pre-stretched elastic inner tube, thereby forming a composite structure in which the elastic filaments and a braided layer are integrated. Compared with the prior art, the elastic filaments are arranged coaxially along the circumference of the elastic inner tube and constrained by the braided layer. After being held in the pre-stretched state, the elastic filaments maintain a consistent retraction ratio with the elastic inner tube upon tension release, which can avoid the issue of relative sliding or delamination of a braided layer in a conventional expandable hose caused by mismatched thermal expansion and contraction of materials. As a result, the fatigue resistance and service life of the expandable hose under repeated extreme expansion and retraction cycles can be significantly improved. The plurality of groups of elastic filaments distributed circumferentially exert a “hooping effect” on the elastic inner tube in the braided layer, and can effectively suppress radial expansion and axial creep of the elastic inner tube under high-pressure water flow or external force. Consequently, the present disclosure guarantees the roundness and dimensional stability of the expandable hose under an operating pressure (such as 0.5 MPa to 2 MPa) and avoids the risk of bursting or deformation failure of the elastic inner tube.

The present disclosure features a high integration level, eliminating the need for step-by-step prefabrication of an elastic filament layer or secondary adhesive bonding. The present disclosure enables a braiding speed as high as 20 m/min to 50 m/min. In addition, the synchronous material elongation assembly can accurately control a stretch ratio of 2 to 4. Compared with conventional step-by-step assembly processes, the present disclosure improves the production efficiency by 2 times to 3 times, reduces the overall manufacturing cost by 25% to 30%, and allows braiding according to a desired length.

### BRIEF DESCRIPTION OF THE DRAWINGS

FIG. 1 is a front view of the in-situ braiding apparatus of the present disclosure;

FIG. 2 is a perspective view of the in-situ braiding apparatus of the present disclosure;

FIG. 3 is a perspective view of the in-situ braiding apparatus of the present disclosure;

FIG. 4 is an enlarged view of A shown in FIG. 3;

FIG. 5 is a perspective view of a spindle in the in-situ braiding apparatus of the present disclosure;

FIG. 6 is a perspective view of the in-situ braiding apparatus of the present disclosure (with a support and a cover plate partially omitted);

FIG. 7 is a schematic view of a braided structure of the expandable hose obtained in the present disclosure;

FIG. 8 is a schematic cross-sectional view of the expandable hose obtained in the present disclosure;

FIG. 9 is a picture of the in-situ braided hose of the present disclosure on which connectors and a spray nozzle are arranged;

FIG. 10 is a picture of the in-situ braided hose of the present disclosure through which no water is flowing;

FIG. 11 is a picture of the in-situ braided hose of the present disclosure through which water is flowing;

FIG. 12 is a perspective view of an end of the expandable hose in the present disclosure that is to be connected to a faucet and is provided with a flexible connecting sleeve;

FIG. 13 is a cross-sectional view of FIG. 12 along an axial direction of the expandable hose; and

FIG. 14 shows a method for in-situ braiding an expandable hose.

### REFERENCE NUMERALS

1—support; 2—braiding unit; 21—drive motor; 22—dial; 23—spindle; 24—guide tube; 25—pre-positioning tube; 26—U-shaped connector; 3—first feeding unit; 31—first nip roller assembly; 4—second feeding unit; 41—rotation roller; 42—separation plate; 43—support frame; 44—second nip roller assembly; 5—rotary hook; 6—winding unit; 7—rotational speed adjustment assembly; 71—second synchronizing shaft; 72—synchronous chain-gear assembly; 73—first synchronizing shaft; 74—transmission gear; 75—first chain-gear assembly; 76—second chain-gear assembly; 77—winding chain-gear assembly; 8—synchronous material elongation assembly; 81—pulling roller; 82—pressing roller; 9—alignment tube; 100—elastic inner tube; 200—braided layer; 201—braiding yarn; 202—elastic filament; 300—connector; 400—fastening ring; 500—flexible connecting sleeve; 510—wrapping portion; 520—extension portion; 521—hollowed-out gap; 530—gap; and 540—concave-convex anti-slip portion.

### DETAILED DESCRIPTION OF THE EMBODIMENTS

To further explain the technical solutions of the present disclosure, the present disclosure will be described in detail below through specific embodiments.

### Embodiment 1

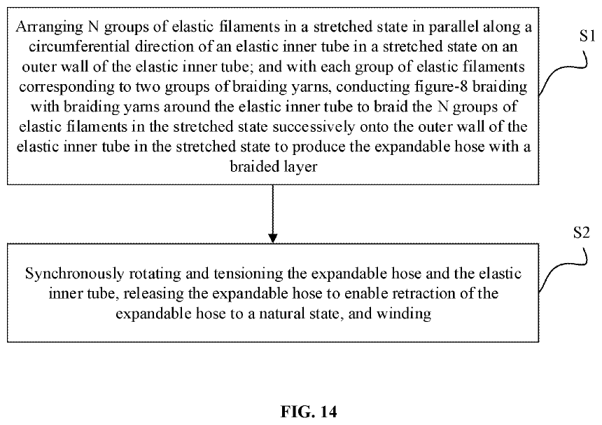

In this embodiment, as shown in FIG. 14, a method for in-situ braiding an expandable hose is disclosed, including the following steps:

In S1, N groups of elastic filaments in a stretched state are arranged in parallel along a circumferential direction of an elastic inner tube in a stretched state on an outer wall of the elastic inner tube. With each group of elastic filaments corresponding to two groups of braiding yarns, figure-8 braiding is conducted with braiding yarns around the elastic inner tube to braid the N groups of elastic filaments in the stretched state successively onto the outer wall of the elastic inner tube in the stretched state to produce the expandable hose with a braided layer.

In S2, the expandable hose obtained in the S1 and the elastic inner tube are synchronously rotated and tensioned, the expandable hose is then released to enable retraction of the expandable hose to a natural state, and then wound.

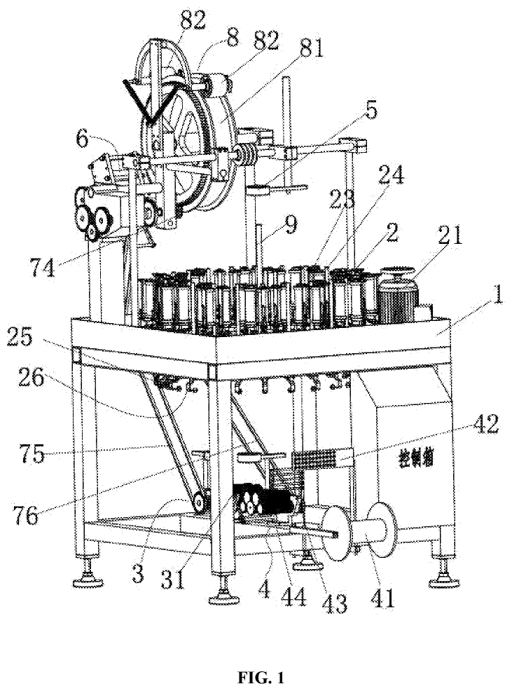

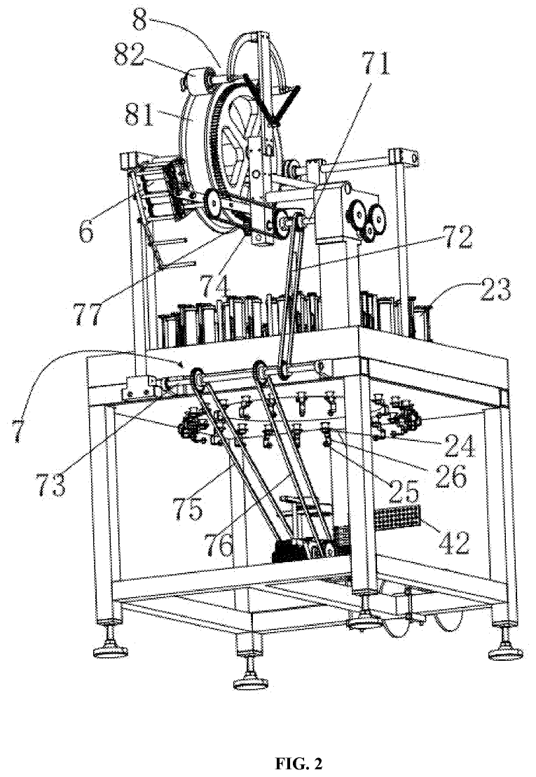

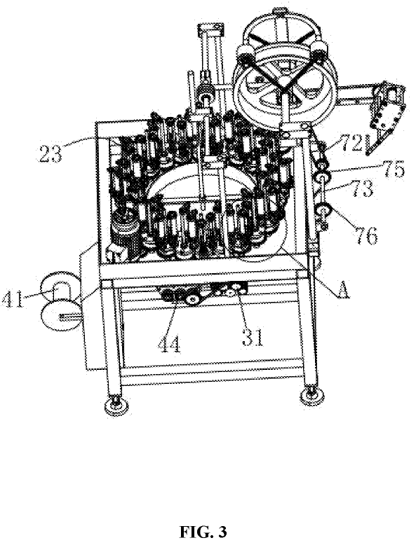

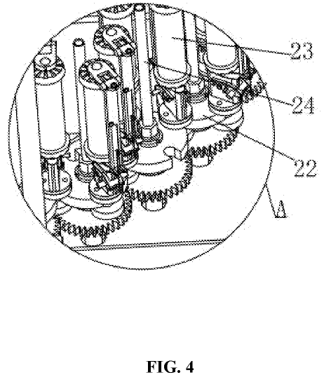

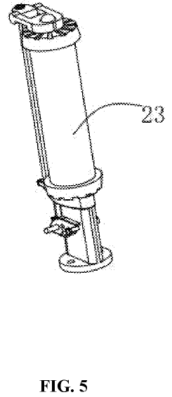

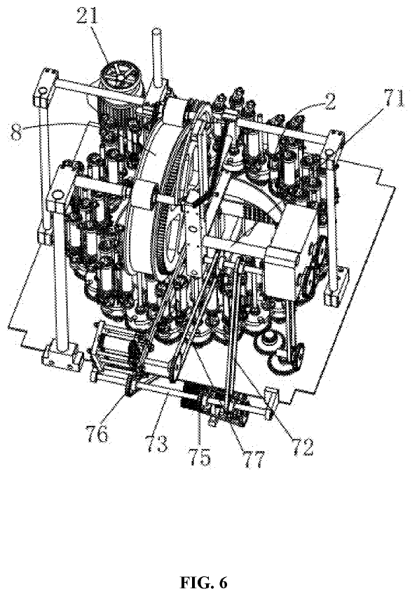

In this embodiment, the figure-8 braiding in the S1 is implemented by an in-situ braiding apparatus. As shown in FIG. 1 to FIG. 6, the in-situ braiding apparatus includes a braiding unit 2 arranged on a support 1. A first feeding unit 3 configured to supply the elastic inner tube and a second feeding unit 4 configured to supply the elastic filaments are provided below the braiding unit 2. A rotary hook 5 and a winding unit 6 are provided above the braiding unit 2. The first feeding unit 3, the second feeding unit 4, and the winding unit 6 are rotated synchronously through a rotational speed adjustment assembly 7. Along a discharging direction of the expandable hose, a synchronous material elongation assembly 8 driven synchronously by the rotational speed adjustment assembly 7 is further provided between the winding unit 6 and the rotary hook 5. In this embodiment, the braiding unit 2 includes a drive motor 21 horizontally arranged above the support 1, and an 8-shaped annular track that includes an inner track and an outer track and is arranged on a table surface of the support 1. Driven by the drive motor 21, adjacent dials 22 are rotated in opposite directions to drive spindles 23 located on the inner track and the outer track to move cyclically along the 8-shaped annular track with intersecting paths, such that elastic filaments 202 passing through middle portions of the dials 22 are cross-braided into the braided layer 200. In this embodiment, a braided layer is braided in-situ on a surface of the elastic inner tube by the braiding unit 2, such that the braided layer uniformly wraps or surrounds the surface of the elastic inner tube.

In this embodiment, a guide tube 24 configured to introduce elastic filaments is provided at a center of each dial 22, and a pre-positioning tube 25 arranged coaxially with the guide tube 24 is provided below the guide tube 24. In this embodiment, the arrangement of the pre-positioning tube 25 and the guide tube 24 in cooperation ensures stable and smooth feeding of elastic filaments during braiding, reducing bending of the elastic filaments.

In this embodiment, the guide tube 24 and the pre-positioning tube 25 are spaced apart and fixedly connected by a U-shaped connector 26. In this embodiment, the U-shaped connector 26 is further provided between the guide tube 24 and the pre-positioning tube 25 to ensure a sufficient distance between the guide tube 24 and the pre-positioning tube 25, thereby improving the smoothness of feeding of the elastic filaments.

In this embodiment, the first feeding unit 3 includes a first nip roller assembly 31 configured to cooperate with the winding unit 6 to tension the elastic inner tube in a feeding direction, and the second feeding unit 4 includes a rotation roller 41, a separation plate 42 provided with through holes for elastic filaments to pass through one by one, a support frame 43, and a second nip roller assembly 44 sequentially in a feeding direction of the elastic filaments. In this embodiment, elastic filaments 202 are supplied by the second feeding unit 4. Elastic filaments 202 stored on the rotation roller 41 pass through the separation plate 42 provided with the through holes for the elastic filaments 202 to pass through one by one, the support frame 43, and the second nip roller assembly 44 sequentially for guiding, then pass through guide passages formed inside a positioning ring to enter guide tubes 24 and pre-positioning tubes 25 one by one, and are then guided along a length direction of the elastic inner tube 100 to a braiding point at which the elastic filaments are braided together with braiding yarns 201 into the braided layer 200.

In this embodiment, the winding unit 6 clamps an end of the braided expandable hose, the elastic inner tube is clamped by the first nip roller assembly 31, and the elastic filaments are clamped by the second nip roller assembly 44. Consequently, the synchronous material elongation assembly 8 arranged in the middle can synchronously tension and stretch the elastic inner tube and the elastic filaments.

In this embodiment, the rotational speed adjustment assembly 7 includes a second synchronizing shaft 71 driven by the drive motor 21 to rotate, and the second synchronizing shaft 71 synchronously drives a first synchronizing shaft 73 to rotate through a synchronous chain-gear assembly 72. The second synchronizing shaft 71 is driven by the drive motor 21 through gear transmission of the braiding unit 2. That is, in this embodiment, only one drive motor 21 is required to achieve braiding, synchronous feeding of the elastic filaments and the elastic inner tube, and discharging of the expandable hose.

In this embodiment, the second synchronizing shaft 71 drives a pulling roller 81 of the synchronous material elongation assembly 8 to rotate through a transmission gear 74. The second synchronizing shaft 71 drives the winding unit 6 to rotate synchronously through a winding chain-gear assembly 77. In this embodiment, the second synchronizing shaft 71 provides a rotational force for the pulling roller 81 and the winding unit 6.

In this embodiment, the first synchronizing shaft 73 drives the first nip roller assembly 31 of the first feeding unit 3 through a first chain-gear assembly 75. The first synchronizing shaft 73 drives the second nip roller assembly 44 of the second feeding unit 4 through a second chain-gear assembly 76. In this embodiment, driving the first nip roller assembly 31 and the second nip roller assembly 44 by the first synchronizing shaft 73 effectively enhances the synchronization of feeding of the elastic filaments and the elastic inner tube. The present disclosure ensures a consistent linear velocity for the elastic inner tube, the elastic filaments, and the expandable hose throughout the entire braiding and winding process, avoids braiding defects or slack elastic filaments caused by uneven local tension, improves the qualified rate of finished products to 95% or more.

In this embodiment, the synchronous material elongation assembly 8 further includes a pressing roller 82 configured to press the expandable hose against the pulling roller 81. In this embodiment, the pressing roller 82 presses the braided expandable hose, thereby achieving effective and uniform stretching of the expandable hose.

In this embodiment, the elastic inner tube and the elastic filaments are conveyed respectively by the first feeding unit 3 and the second feeding unit 4 to the braiding unit 2, and a braided expandable hose is then wound by the winding unit 6. During the in-situ braiding of the expandable hose, the first feeding unit 3, the second feeding unit 4, and the winding unit 6 are rotated synchronously through the rotational speed adjustment assembly 7. Further, along the discharging direction of the expandable hose, the synchronous material elongation assembly 8 driven synchronously by the rotational speed adjustment assembly 7 is further provided between the winding unit 6 and the rotary hook 5. That is, in this embodiment, the production efficiency of the expandable hose is greatly improved by in-situ braiding the braided layer of the elastic filaments in the stretched state on the surface of the elastic inner tube in the synchronously stretched state, and a length of the expandable hose is not limited.

In this embodiment, an alignment tube 9 penetrating through the support 1 and the braiding unit 2 is further provided below the rotary hook 5 to ensure that the elastic inner tube is positioned at a center of the braiding unit 2.

In this embodiment, the synchronous material elongation assembly 8 is linked with the rotational speed adjustment assembly 7 to simultaneously pull the elastic inner tube 100 and the elastic filaments 202 such that the elastic filaments and the elastic inner tube are synchronously stretched from a natural length to a length 2.8 times the natural length. Consequently, the elastic inner tube 100 and the elastic filaments 202 can maintain a consistent pre-stretched state in a braiding region for in-situ braiding, thereby enabling a synchronous deformation after water is introduced into the expandable hose.

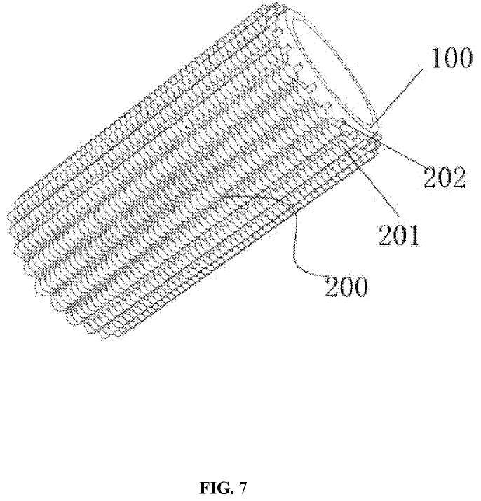

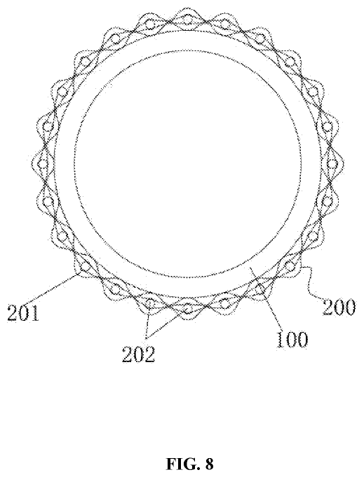

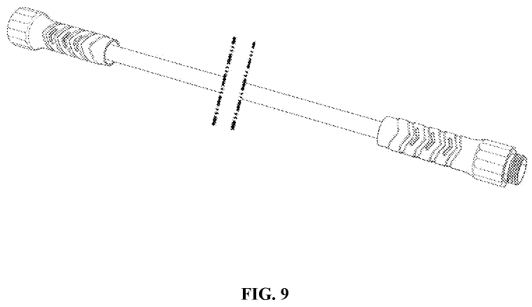

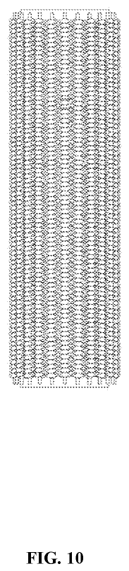

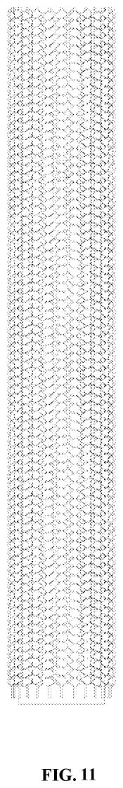

In this embodiment, an in-situ braided expandable hose is provided. As shown in FIG. 7 to FIG. 11, the expandable hose includes an elastic inner tube 100 and a braided layer 200 that is braided on an outer wall of the elastic inner tube 100 and is capable of expanding and retracting synchronously with the elastic inner tube 100. The braided layer 200 is formed through the interlaced braiding of a plurality of strands of braiding yarns 201 with a plurality of groups of elastic filaments 202 arranged along an axial direction of the elastic inner tube. When the expandable hose is in a natural elongated state, the elastic filaments 202 remain pre-stretched to provide an additional retraction force and a circumferential limiting effect for the elastic inner tube.

In this embodiment, spandex is adopted as the elastic filaments, and polyester yarns are adopted as the braiding yarns.

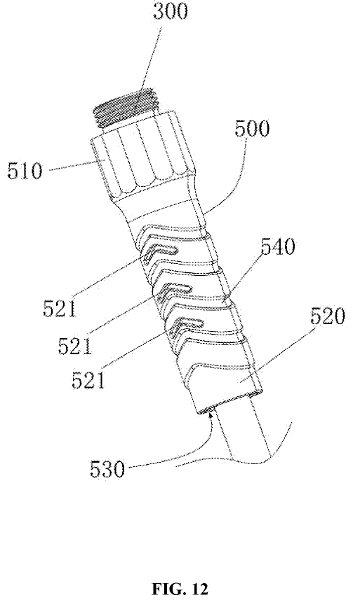

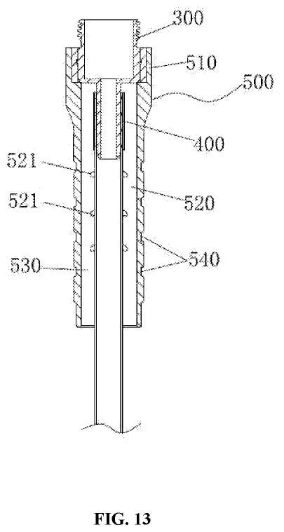

As shown in FIG. 12 and FIG. 13, in this embodiment, the expandable hose is capable of being threadedly connected to a water source or a spray nozzle through connectors 300 at two ends of the expandable hose. The expandable hose is tightly sleeved onto the connectors 300 through fastening rings 400. A flexible connecting sleeve 500 is fixed on an outer side of each of junctions between the expandable hose and the connectors 300. In the present disclosure, the arrangement of the flexible connecting sleeve 500 facilitates a user in manually achieving the threaded connection of the expandable hose with the connectors 300 to a spray nozzle or a water source, such as a water supply pipe or a faucet. This design enhances the convenience of use of the present disclosure.

In this embodiment, the flexible connecting sleeve 500 is fixedly arranged on a connector 300 through a deformation of the flexible connecting sleeve. In the present disclosure, the connector 300 is typically a hardware fitting with an undercut on a surface. The flexible connecting sleeve 500 achieves a reliable connection with the hardware fitting 300 by enclosing the undercut of the connector 300 through a deformation of the flexible connecting sleeve 500.

In this embodiment, the flexible connecting sleeve 500 includes a wrapping portion 510 tightly fitted to a connector 300 through a deformation, and an extension portion 520 configured to enclose a junction between the expandable hose and the connector 300. In the present disclosure, the flexible connecting sleeve 500 is preferably made of TPE through integral molding. With the integrally formed flexible connecting sleeve 500 in the present disclosure, a user can conveniently hold an end of the expandable hose to connect or disconnect the expandable hose to or from a water source or a spray nozzle.

In this embodiment, the extension portion 520 is provided with hollowed-out gaps 521 that are spaced apart. In the present disclosure, the spaced hollowed-out gaps 521 formed in the extension portion 520 of the flexible connecting sleeve 500 can accommodate bending between the hardware fitting 300 and the expandable hose. This design prevents the expandable hose from kinking, ensures smooth water flow, and reduces structural damage to the expandable hose.

In this embodiment, when no water is flowing in the expandable hose, a gap 530 exists between the extension portion 520 and the expandable hose. The flexible connecting sleeve 500 of the present disclosure accommodates radial expansion of the expandable hose.

In this embodiment, the flexible connecting sleeve 500 is provided with concave-convex anti-slip portions 540 to improve the stability and reliability of hand-held operation.

### Embodiment 2

This embodiment is different from Embodiment 1 mainly in that:

The synchronous material elongation assembly 8 is linked with the rotational speed adjustment assembly 7 to simultaneously pull the elastic inner tube and the elastic filaments such that the elastic filaments and the elastic inner tube are synchronously stretched from a natural length to a length 2 times the natural length.

### Embodiment 3

This embodiment is different from Embodiment 1 mainly in that:

The synchronous material elongation assembly 8 is linked with the rotational speed adjustment assembly 7 to simultaneously pull the elastic inner tube and the elastic filaments such that the elastic filaments and the elastic inner tube are synchronously stretched from a natural length to a length 4 times the natural length.

### Comparative Embodiment 1

This comparative example is different from Embodiment 1 mainly in that:

No elastic filaments are braided into the braided layer, and the braided layer is braided with merely the elastic inner tube in the pre-stretched state present.

### Comparative Embodiment 2

This comparative example is different from Embodiment 1 mainly in that:

The figure-8 braiding is conducted with the elastic filaments and the elastic inner tube in normal pulling states.

Water was introduced into the expandable hoses obtained in Embodiments 1 to 3 and Comparative Embodiments 1 and 2 for 20 min under a water pressure of 1 MPa. A radial expansion rate, an axial elongation rate, and an expansion and retraction consistency retention rate after 5,000 water on/off cycles were each tested. The detailed data was shown in Table 1. Specific calculation methods are as follows:

$$Radial expansion rate ( \% ) = ( {D}_{water on} - {D}_{natural} ) / {D}_{natural} * 100 \%$$

where Dₙₐₜᵤᵣₐₗ represents an outer diameter of any cross section in a naturally retracted state (mm), which is an average of 3 positions; and D_{water on} represents an outer diameter in a stable water-on state (mm).

Axial elongation rate=L_{water on}/Lₙₐₜᵤᵣₐₗ, where Lₙₐₜᵤᵣₐₗ represents a total length in a naturally retracted state (end-to-end); and L_{water on} represents a total length in a water-on state (end-to-end).

Expansion and retraction consistency retention rate (%)=P_{5000th cycle}/P_{1st cycle}*100%, where P_{1st cycle} represents an elongation rate/ratio baseline value after the 1st water on/off cycle; and P_{5000th cycle} represents an elongation rate/ratio after the 5000th water on/off cycle. One complete water on/off cycle was defined as follows: Water was introduced to maintain water pressure for 1 min, then the water introduction was stopped, and retraction was allowed for 5 min.

TABLE 1
Performance test data of Embodiments 1 to
3 and Comparative Embodiments 1 and 2

| | Radial | Axial | Expansion and retraction |
|---|---|---|---|
| | expansion | elongation | consistency retention |
| Item | rate (%) | rate | rate (%) |
| Embodiment 1 | 48 | 3.2 | 92 |
| Embodiment 2 | 42 | 2.5 | 88 |
| Embodiment 3 | 52 | 3.5 | 89 |
| Comparative | 35 | 2.1 | 75 |
| Embodiment 1 | | | |
| Comparative | 28 | 1.6 | 68 |
| Embodiment 2 | | | |

In the present disclosure, the elastic filaments and the elastic inner tube are synchronously pre-stretched to the same ratio during braiding. As a result, during retraction after braiding, the elastic filaments and the elastic inner tube exhibit the same phase change curve due to elastic memory. When water is introduced, the water pressure causes the elastic inner tube to expand, with a radial expansion rate of 42% to 52% and an axial elongation rate of 2.5 to 3.5. The braiding yarns provide the final limit, and the elastic filaments absorb differential expansion stress. Consequently, the braided layer can uniformly elongate with the elastic inner tube without relative displacement or abrasion, thereby achieving a synchronous deformation. Test results show that, after the 5,000 water on/off cycles, the expandable hose of the present disclosure still retains an expansion and retraction consistency retention rate of 85% or more.

In the present disclosure, pre-stretched elastic filaments and braiding yarns are braided together along a figure-8 intersecting path on an outer wall of a synchronously pre-stretched elastic inner tube, thereby forming a composite structure in which the elastic filaments and a braided layer are integrated. Compared with the prior art, the elastic filaments are arranged coaxially along the circumference of the elastic inner tube and constrained by the braided layer. After being held in the pre-stretched state, the elastic filaments maintain a consistent retraction ratio with the elastic inner tube upon tension release, which can avoid the issue of relative sliding or delamination of a braided layer in a conventional expandable hose caused by mismatched thermal expansion and contraction of materials. As a result, the fatigue resistance and service life of the expandable hose under repeated extreme expansion and retraction cycles can be significantly improved. The plurality of groups of elastic filaments distributed circumferentially exert a “hooping effect” on the elastic inner tube in the braided layer, and can effectively suppress radial expansion and axial creep of the elastic inner tube under high-pressure water flow or external force. Consequently, the present disclosure guarantees the roundness and dimensional stability of the expandable hose under an operating pressure (such as 0.5 MPa to 2 MPa) and avoids the risk of bursting or deformation failure of the elastic inner tube. The expandable hose obtained in the present disclosure can withstand a water pressure of 8 MPa with a stable structure and a controllable radial expansion rate, and maintains structural stability during use.

The present disclosure features a high integration level, eliminating the need for step-by-step prefabrication of an elastic filament layer or secondary adhesive bonding. The present disclosure enables a braiding speed as high as 20 m/min to 50 m/min. In addition, the synchronous material elongation assembly 8 can accurately control a stretch ratio of 2 to 4. Compared with conventional step-by-step assembly processes, the present disclosure improves the production efficiency by 2 times to 3 times, reduces the overall manufacturing cost by 25% to 30%, and allows braiding according to a desired length.

What is claimed is:

1. A method for in-situ braiding an expandable hose, comprising following steps:
S1, arranging N groups of elastic filaments in a stretched state in parallel along a circumferential direction of an elastic inner tube in a stretched state on an outer wall of the elastic inner tube; and with each group of elastic filaments corresponding to two groups of braiding yarns, conducting figure-8 braiding with braiding yarns around the elastic inner tube to braid the N groups of elastic filaments in the stretched state successively onto the outer wall of the elastic inner tube in the stretched state to produce the expandable hose with a braided layer; and
S2, synchronously rotating and tensioning the expandable hose and the elastic inner tube, releasing the expandable hose to enable retraction of the expandable hose to a natural state, and winding.

2. The method according to claim 1, wherein the figure-8 braiding in the S1 is implemented by an in-situ braiding apparatus; and the in-situ braiding apparatus comprises a braiding unit arranged on a support, wherein a first feeding unit configured to supply the elastic inner tube and a second feeding unit configured to supply the elastic filaments are provided below the braiding unit; a rotary hook and a winding unit are provided above the braiding unit;
the first feeding unit, the second feeding unit, and the winding unit are rotated synchronously through a rotational speed adjustment assembly; and
along a discharging direction of the expandable hose, a synchronous material elongation assembly driven synchronously by the rotational speed adjustment assembly is further provided between the winding unit and the rotary hook.

3. The method according to claim 2, wherein
the braiding unit comprises a drive motor horizontally arranged above the support, and an 8-shaped annular track that comprises an inner track and an outer track and is arranged on a table surface of the support; driven by the drive motor, adjacent dials are rotated in opposite directions to drive spindles located on the inner track and the outer track to move cyclically along the 8-shaped annular track with intersecting paths, such that elastic filaments passing through middle portions of the dials are cross-braided into the braided layer.

4. The method according to claim 3, wherein
a guide tube configured to introduce elastic filaments is provided at a center of each dial, and a pre-positioning tube arranged coaxially with the guide tube is provided below the guide tube; and
the guide tube and the pre-positioning tube are spaced apart and are fixedly connected by a U-shaped connector.

5. The method according to claim 2, wherein the first feeding unit comprises a first nip roller assembly configured to cooperate with the winding unit to tension the elastic inner tube in a feeding direction; and
the second feeding unit comprises a rotation roller, a separation plate provided with through holes one by one, a support frame, and a second nip roller assembly sequentially in a feeding direction of the elastic filaments.

6. The method according to claim 5, wherein the elastic filaments are supplied by the second feeding unit; and elastic filaments stored on the rotation roller pass through a separation plate provided with through holes for elastic filaments to pass through one by one, a support frame, and a second nip roller assembly sequentially for guiding, then pass through guide passages formed inside a positioning ring to enter guide tubes and pre-positioning tubes one by one, and are then guided along a length direction of the elastic inner tube to a braiding point at which the elastic filaments are braided together with braiding yarns into the braided layer.

7. The method according to claim 2, wherein
the synchronous material elongation assembly synchronously pulls the elastic filaments and the elastic inner tube to stretch to a length 2 times to 4 times an original length.

8. The method according to claim 5, wherein
the rotational speed adjustment assembly comprises a second synchronizing shaft driven by a drive motor to rotate, and the second synchronizing shaft synchronously drives a first synchronizing shaft to rotate through a synchronous chain-gear assembly;
the second synchronizing shaft drives a pulling roller of the synchronous material elongation assembly to rotate through a transmission gear;
the second synchronizing shaft drives the winding unit to rotate synchronously through a winding chain-gear assembly;
the first synchronizing shaft drives the first nip roller assembly of the first feeding unit through a first chain-gear assembly; and
the first synchronizing shaft drives the second nip roller assembly of the second feeding unit through a second chain-gear assembly.

9. An expandable hose in-situ braided by the method according to claim 1.

10. The expandable hose according to claim 9, comprising an elastic inner tube and a braided layer that is braided on an outer wall of the elastic inner tube and is capable of expanding and retracting synchronously with the elastic inner tube.

11. The expandable hose according to claim 10, wherein
the expandable hose is capable of being threadedly connected to a water source or a spray nozzle through connectors at two ends of the expandable hose; the expandable hose is tightly sleeved onto the connectors through fastening rings; and a flexible connecting sleeve is fixed on an outer side of each of junctions between the expandable hose and the connectors.

12. The expandable hose according to claim 11, wherein the flexible connecting sleeve is fixedly arranged on a connector through a deformation of the flexible connecting sleeve.

13. The expandable hose according to claim 11, wherein the flexible connecting sleeve comprises a wrapping portion tightly fitted to a connector through a deformation, and an extension portion configured to enclose a junction between the expandable hose and the connector.

14. The expandable hose according to claim 13, wherein the extension portion is provided with hollowed-out gaps that are spaced apart.

15. The expandable hose according to claim 13, wherein when no water is flowing in the expandable hose, a gap exists between the extension portion and the expandable hose.

16. The expandable hose according to claim 11, wherein the flexible connecting sleeve is provided with concave-convex anti-slip portions.
